(19) United States
(12) Patent Application Publication
(10) Pub. No.: US 2005/0210933 A1
(43) Pub. Date: Sep. 29, 2005

(54) Interlock device for locker

(76) Inventor: Cheng-Kan Wen, Taipei (TW)

Correspondence Address: BRUCE H. TROXELL, SUITE 1404, 5205 LEESBURG PIKE, FALLS CHURCH, VA, 22041, US

(21) Appl. No.: 11/084,131

(22) Filed: Mar. 21, 2005

(30) Foreign Application Priority Data
Mar. 23, 2004 (TW) 93204351

(51) Int. Cl. E05B 65/44; E05B 65/46

(52) U.S. Cl. 70/78; 70/85

(57) ABSTRACT

An improved interlock device arranged in a locker comprises a cylinder, a poking rod, a frame, a plurality of wedging blocks, a latch structure, and a safety device. Wherein, the cylinder is arranged at the upper portion of the front panel of the locker and is adapted for locking or unlocking the locker; the front of the poking rod is connected to the cylinder, and the frame, being arranged at the rear of the locker, is a hollow square bar, and the latch structure is fitted inside the frame and is capable of moving upwardly and downwardly with the poking rod by connecting an side of the latch structure to one end of the poking rod, and the latch structure further comprises: a latch piece and a poke-positioning mechanism. The invention improves the structure of latch structure and the wedging block, wherein a curved hook at the tail of the poking rod brings along the latch piece to move up and down for locking and unlocking the locker, such that the invention cooperating with the safety device not only has the function to limit the number of drawer that can be open at the same time, but also has the function of pushing in the unlocked drawer to be automatically locked. The activating manner of the entire latch structure may effectively solve the shortcoming of the prior arts

### FIELD OF THE INVENTION

The present invention is related to an improved interlock device for locker, and more particularly, to an improved interlock device for locker capable of restricting the locker to open only one drawer thereof at a time, and effectively preventing the drawers thereof from opening by itself and falling out of the locker while the locker is unlocked.

### BACKGROUND OF THE INVENTION

In a common locker or locker, there is a locking up structure arranged therein for locking purpose. Please refer to FIG. 1, which is an exploded view of a conventional lock for locker. The lock mainly comprises a cylinder A, a trigger bar B, a latch piece C, and a plurality of wedging blocks D. Wherein, the wedging block D is fixed at the rear of each drawer of the locker E; the cylinder A is arranged at the upper portion of the front panel of the locker E; and the latch piece C is arranged at the rear of the locker E. Moreover, a latch hole F is arranged on the latch piece C at a position corresponding to each wedging block D, and the front end and the rear end of the trigger bar B are respectively connected to the cylinder A and the latch piece C, such that a user may apply the cylinder A through the trigger bar B to bring along the latch piece C for changing the corresponding position between the latch hole F and the wedging block D so as to achieve the function of locking or unlocking the drawers of the locker E.

However, in a conventional locker, there is usually provided casters at the bottom thereof to enhance its mobility. In addition, the drawers of the locker may be opened and drawn out for easily accessing things held in the locker, and usually more than one drawers were be opened at the same time for finding articles or other reasons. When more than one drawers are opened and drawn out, it might result in the entire locker being tilted over due to the unbalanced weight distribution because of the gravity center of the locker is changed, and thus cause danger of injury on users or damage to itself.

This application is related to the U.S. patent “LOCKER LOCK IMPROVEMENT”, U.S. Pat. No. 5,862,689 with reference to FIG. 2, which shows an exploded view of an improved interlock mechanism according to the U.S. Pat. No. 5,862,689. The lock mainly comprises: a cylinder G, a trigger bar I, latch element J, and latch hook K, wherein an end of the trigger bar I is connected to a groove H arranged at the rear center of the cylinder G, and another end of the trigger bar I passes through the latch element J fixed at the upper portion of the inner wall of the locker, and the latch hook K is an elongated frame with a plurality of opening L arranged thereon that the latch hook K can be turned in clockwise or counter clockwise direction for locking or unlocking in respective. Therefore, the forgoing lock is capable of enabling a drawn out drawer to be closed and locked again smoothly without causing any damage even when the lock of the locker is at a locked condition, and limiting the number of drawers to be drawn out at one time.

However, although the aforementioned structure may limit the number of drawers of a locker to be drawn out at one time, the height of the side plates of the common drawer is generally low so that the articles placed in the drawer is easily protruding out of the rear side plate of the drawer or even falling into the space between the rear side of the drawer and the rear plate of the locker, and the protruding or dropped articles are abutted against the latch hook K that causes the latch hook K unable to rotate smoothly to lock or unlock the locker. If the locker is unable to be locked as a protruding or dropped article prevent a drawer to be closed, users still can remove the blocked articles as the blocked drawer can be removed for removing the blocking articles. However, if it happens when the locker is locked, a maintenance person with special tools must be called to unlock the locker that, under these situations, it really causes a lot of inconvenience and harassment to the user.

In addition, although the conventional interlock mechanism can restrict the locker to open only one drawer thereof at a time, but it has no safety device to prevent other drawers from opening by accident causing the gravity center of the locker to change and eventually resulting the entire locker to tilt over.

To sum up, there are still many shortcomings in the prior arts to be further studied and improved, including:
1. It is usually unable to predict the size and shape of the article placed in the locker, such as large bundle of electric wire, large towel, or small screw, etc., which are sometimes protruding out of the rear part of the locker or dropped to the neighborhood of the latch hook K so that cause the latch hook K to be unable to execute the locking or unlocking function.
2. The conventional interlock mechanism having no safety device to prevent the drawers of the locker from being opened by external forces that can cause all kinds of accident, not to mention the inconvenience and harassment to the user.
3. Currently, the safely locking structure, capable of restricting the locker to open only one drawer at a time so as to avoid the locker from falling down, did not consider the situation as following: after the cylinder is closed, there are still drawers unlocked? A user usually will push the unclosed drawer into its closed position without noticing that the cylinder has already at locked condition, so a violent collision between the latch piece and the wedging block will cause a damage to entire structure.

Therefore, an improved interlock device for locker is required.

### SUMMARY OF THE INVENTION

The primary object of the present invention is to provide an improved interlock device for locker, in which an improved latch piece cooperating with a plurality of wedging blocks is pairing with a latch structure with poke-positioning mechanism corresponding to the slanting surface arranged at each wedging block so as to not only restrict the number of the drawer to be opened at one time, but also effectively avoid the articles stored in the drawer from influencing the normal function of the latch piece.

Another object of the present invention is to provide an improved interlock device for locker with a safety device, by which the safety device is capable of preventing any drawer from being opened by accident while the locker is unlocked.

Yet, another object of the present invention is to provide an improved interlock device for locker, wherein an unlocked and opened drawer may be pushed in and locked automatically without the requirement of unlocking the locker to avoid a violent collision between the latch piece and the wedging block from happening.

To achieve the aforementioned objects, the present invention provides an improved interlock device, adapted for a locker, mainly comprising: a cylinder, a poking rod, a latch base, a plurality of wedging blocks, a latch structure, and a safety device. Wherein, the cylinder is arranged at the upper portion of the front panel of the locker and is adapted for locking/unlocking the locker, and one end of the poking rod is wedged fixedly to the groove disposed at the rear center of the cylinder so that the poking rod can be rotated by turning the key inserted in the cylinder, in addition, the latch base is a hollow elongated square bar and is arranged at the inner surface of the locker, and the wedging block is arranged fixedly at the rear of each locker, moreover, the latch structure is fitted in the latch base and is capable of moving upwardly and downwardly with the poking rod by connecting an side of the latch structure to one end of the poking rod, the latch structure featuring: a protruding part is arranged at the outside of the wedging block, and a locking-up part, which is protruding from the bottom surface of the wedging block and is arranged below the protruding part, has a pair of near-vertical-disposed abutting surface arranged at the end of the locking-up part closer to the drawer, and a slanting surface is disposed at another end of the locking-up part, which is parallel with the front side of the protruding part. In addition, the latch structure further comprises: a latch piece and a poke-positioning mechanism, wherein the latch piece is fitted in the latch base that can be moved upwardly and downwardly, and a latch hole is arranged at a position of the latch piece corresponding to the wedging block, and the size of the latch hole is proportional to that of the protruding part of the wedging block, wherein the protruding part may pass through the latch hole by an horizontal movement, and a first groove is disposed at the rear of the poking rod corresponding to the latch piece for a curved hook to pass through. The poke-position mechanism capable of providing resilience to position the latch piece at either a locking or unlocking position can maintain the latch piece at the locking position with the help of the safety device. In this regard, the latch piece is at the unlocking position only when it is pushed by user.

Following drawings are cooperated to describe the detailed structure and its connective relationship according to the invention for facilitating your esteemed members of reviewing committee in understanding the characteristics and the objectives of the invention.

### BRIEF DESCRIPTION OF THE DRAWINGS

FIG. 1 is an exploded view of a conventional improved interlock device for locker.

FIG. 2 is an exploded view of an improved interlock device for locker according to the U.S. Pat. No. 5,862,689.

FIG. 3A is a 3D exploded view of a first embodiment of the present invention.

FIG. 3B is a 3D assembly diagram of a first embodiment of the present invention.

FIG. 4A is a 3D exploded view of a second embodiment of the present invention.

FIG. 4B is a 3D assembly diagram of a second embodiment of the present invention.

FIG. 5A is a front view of the present invention showing the cylinder in a locked state.

FIG. 5B is a front view of the present invention showing that the cylinder is rotated about 90 degrees and the latch piece is in a locked state.

FIG. 5C is a front view of the present invention showing that the button is being pressed for driving the latch piece to the unlocking state.

FIG. 6A is a side view of the present invention showing the positioning of the wedging block and the latch piece as the latch piece is in a locked state.

FIG. 6B is a side view of the present invention showing the positioning of the wedging block and the latch piece as the button is being pressed for driving the latch piece to the unlocking state.

FIG. 6C is a side view of the present invention showing the positioning of the wedging block and the latch piece as a drawer is being drawn out enabling the latch piece to move upward.

FIG. 6D is a side view of the present invention showing the positioning of the wedging block and the latch piece as a drawer is being pushed in enabling the latch piece to move downward.

FIG. 7 is a schematic 3D partial diagram showing a safety device according to a preferred embodiment of the present invention.

FIG. 8 is a schematic 3D view of the present invention.

FIG. 9 is a schematic diagram showing an improved interlock device of the second embodiment being installed in a locker.

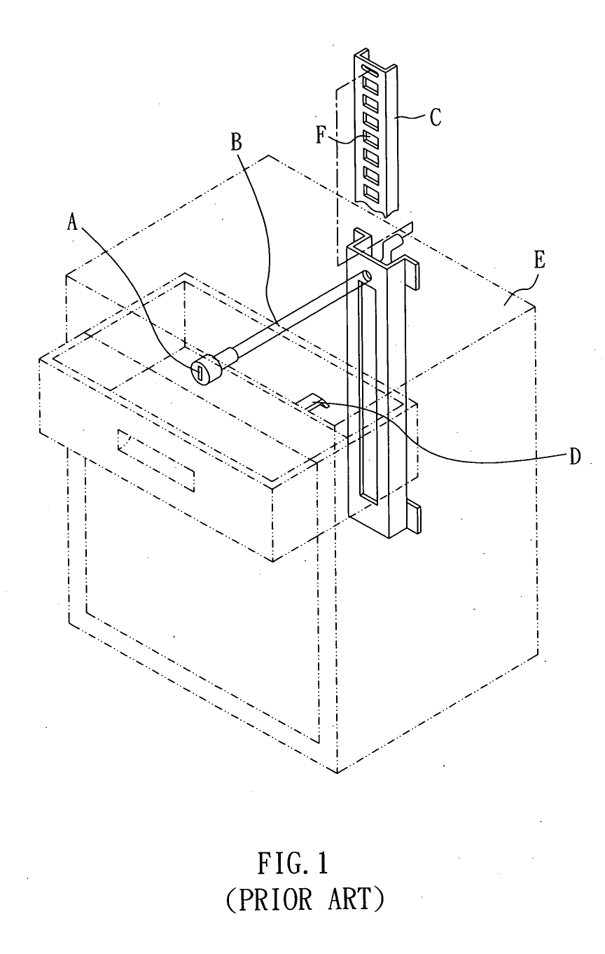

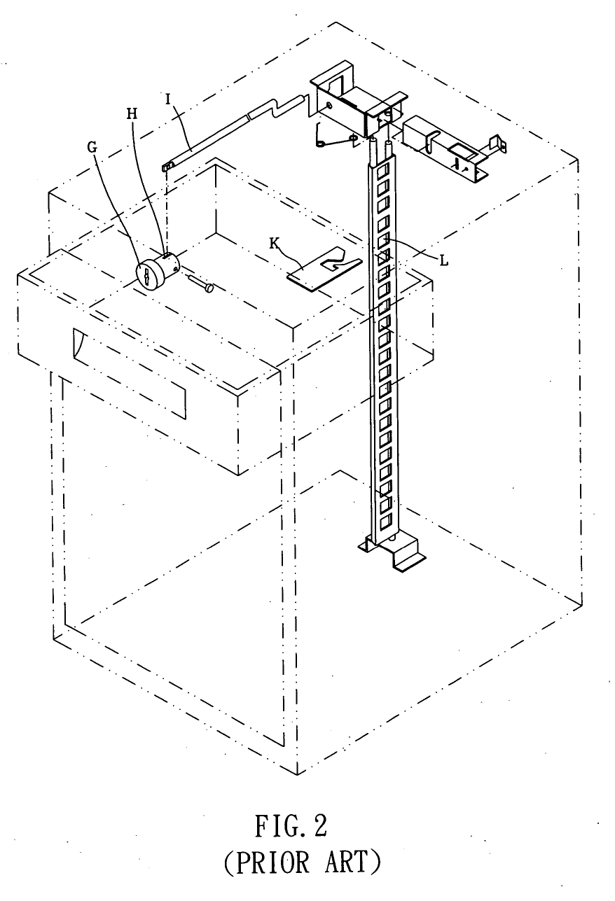

### DETAILED DESCRIPTION OF THE INVENTION

For your esteemed members of reviewing committee to further understand and recognize the fulfilled functions and structural characteristics of the invention, several preferable embodiments cooperating with detailed description are presented as the follows.

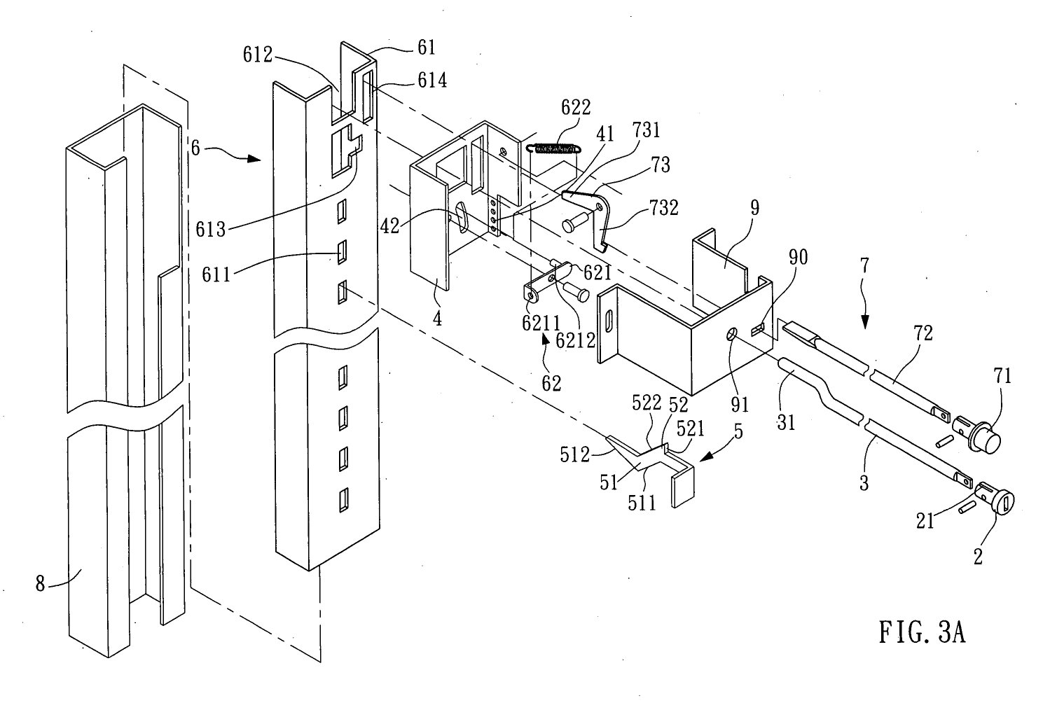

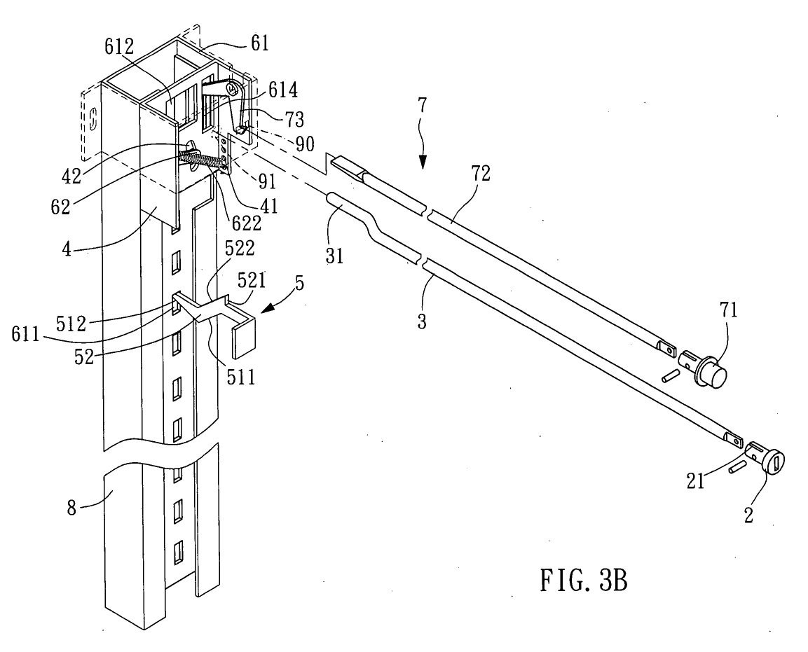

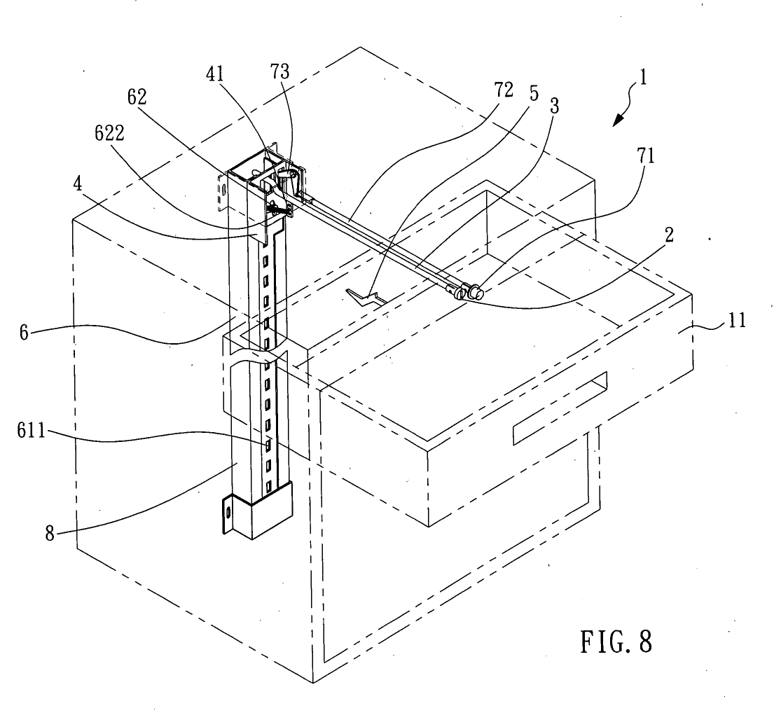

Please refer to FIG. 3A, FIG. 3B, and FIG. 8, which are respectively the 3D explosive views, the 3D assembly view, and the schematic diagram of an improved interlock device for locker according to a first embodiment of the present invention. The improved interlock device of the invention is arranged in a locker 1 having a plurality of drawers arranged therein, and the improved interlock device comprises: a cylinder 2, a poking rod 3, a latch base 4, a plurality of wedging blocks 5, a latch structure 6, a frame 8, a lid 9 and a safety device 7. Wherein, the cylinder 2 is arranged at the upper portion of the front panel of the locker 1 and is adapted for a user to lock or unlock the lockers, and one end of the poking rod 3 is wedged fixedly to the groove 21 disposed at the rear center of the cylinder 2 so that the poking rod 3 can be rotated by turning the key inserted in the cylinder 2, in addition, the frame 8 is a hollow elongated square bar and is arranged at the inner surface of the locker 1, and the wedging block 5 is arranged fixedly at the rear of each drawer 11, moreover, the latch structure 6 is fitted in the frame 8 and is capable of moving upwardly and downwardly along with the poking rod 3 by connecting an side of the latch structure 6 to one end of the poking rod 3, Moreover, a protruding part 51 is arranged at the outer side of the wedging block 5 and the protruding part 51 has a front slanting surface 511 and a back slanting surface 512, and the wedging block 5 further comprises a locking-up part 52 disposed at the upper portion of the wedge block 5, which is protruding from the top side of the wedging block 5 and is arranged above the protruding part 51, and the locking-up part 52 further has a near-vertical-disposed abutting surface 521 arranged at the end of the locking-up part 52 closer to the drawer 11, and a slanting surface 522 disposed at another end of the locking-up part 52, being disposed parallel with the front slanting surface 511 of the protruding part 51 by a distance. In addition, the latch structure 6 further comprises: a latch piece 61 and a poke-positioning mechanism 62, wherein the latch piece 61 is fitted in the frame 8 that can be moved upwardly and downwardly, and a latch hole 611 is arranged at a position of the latch piece 61 corresponding to the wedging block 5. The size of the latch hole is slightly larger than the distance between the slanting surface 522 and the front slanting surface 511 of the protruding part 51 such that the abutting surface 521 of the locking-up part 52 can abut against the upper rim of the latch hole 611 when the protruding part 51 passes through the latch hole 611 and is moving horizontally within a proper range. Moreover, a first groove 612 is disposed at the rear of the poking rod 3 corresponding to the latch piece 61 for a curved hook 31 to pass through, by which the curved hook 31 abuts against the lower hem of the first groove 612 during a locking state. The poke-position mechanism 62 is capable of providing resilience to position the latch piece 61 at either a locking or unlocking position.

The poke-position mechanism 62 is consisted of a rotating block 621 and an elastic element 622, wherein the rotating block 621 is pivotally connected to the latch base 4 by for a proper position near the center of the rotating block 621 enabling the rotating block 621 to revolve freely, and a first fixing seat 6211 is disposed at an end of the rotating block 621 with respect to a second fixing seat 41 disposed on the latch base 4 corresponding to another end of the rotating block 621 such that the two ends of the elastic element 622 are respectively connected to the first fixing seat 6211 and the second fixing seat 41. A column 6212 is arranged at the position of the rotating block near the latch piece 61 that is matched with a transversely arranged second groove 613 on the latch piece and a longitudinally arranged third groove 42 on the latch base 4. The column 6212 inserted into the second groove 613 and the third groove 42 enables the rotating block 621 to rotate driven by the column 6212 while an external force drives the latch piece 61 to bring along the column 6212, and simultaneously the resilience provided by the elastic element 622 restrict the rotating block 621 to move between two predefined positions which also limits the movement of the latch piece 61.

The safety device 7 of the invention comprises a button 71, a linkage rod 72, a blocking piece 73 and a second elastic element 74. The blocking piece 73 has a first blocking surface 731 and a second blocking surface 732, by the disposition of which an included angle is formed in-between. The joint of the two blocking surfaces is pivotally connected to a side of the latch base 4 which is matched with a fourth groove 614 arranged on a corresponding position of the latch piece 61 for the first blocking surface 731 to pass and abut against the upper edge of the fourth groove 614. The button 71 is pivotally connected to the front of the linkage rod 72 and the front of the button 71 is protruding the surface of the locker 1. The tail of the linkage rod 72 passes through the lid 9 and abuts against the second blocking surface 732 of the block piece 73.

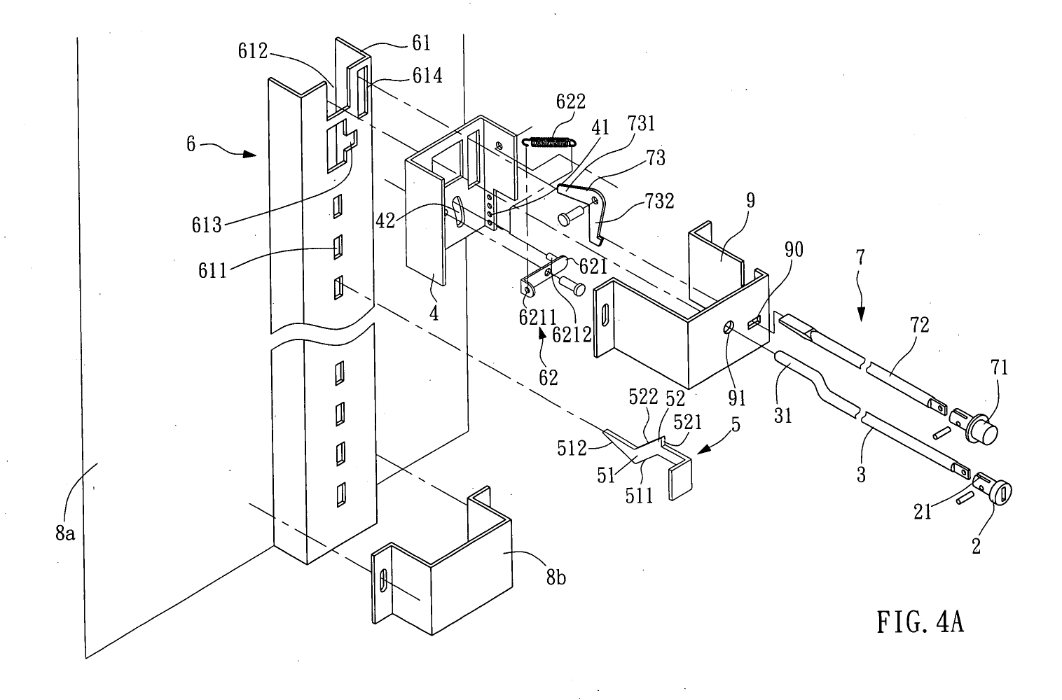

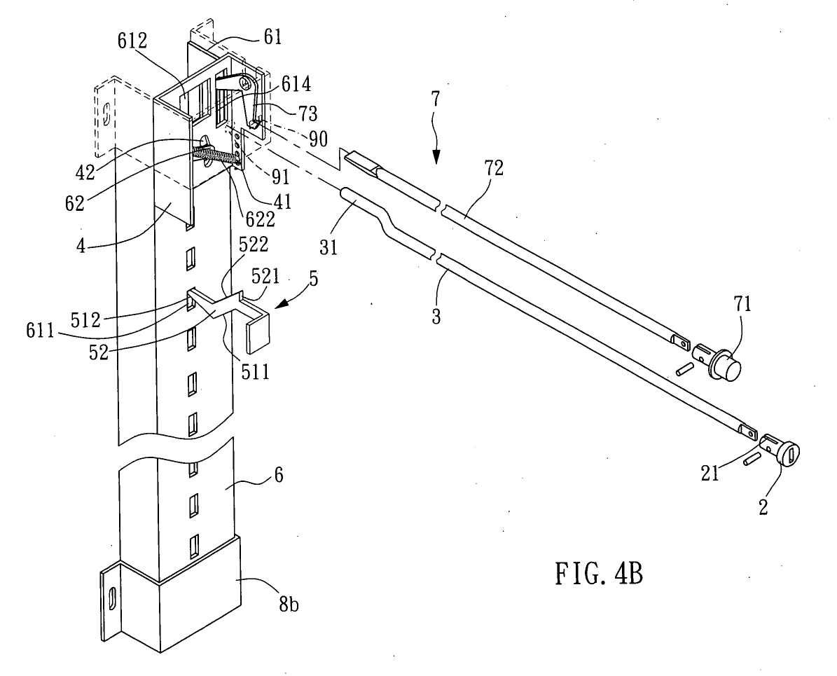

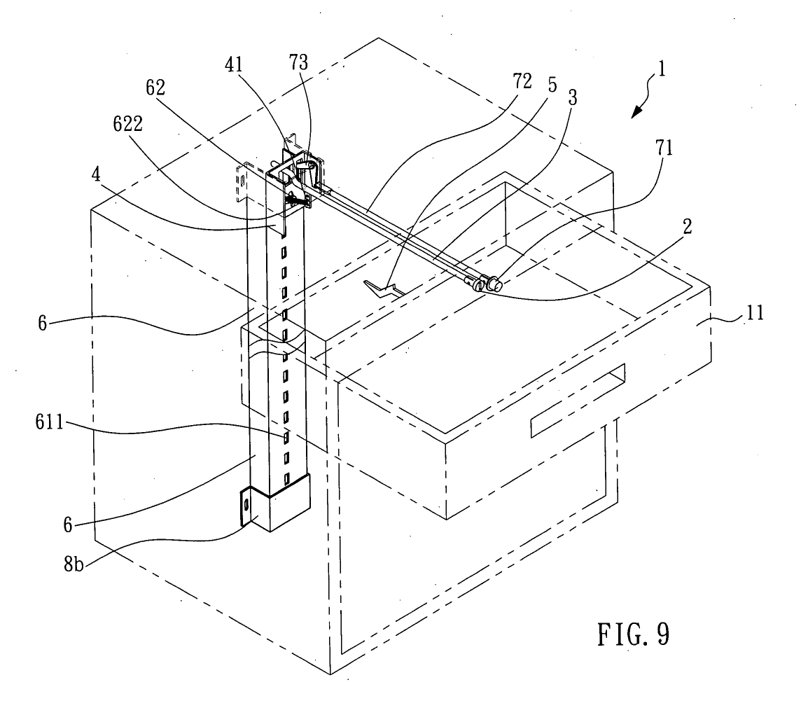

Please refer to FIG. 4A, FIG. 4B, and FIG. 9, which are respectively the 3D explosive views, the 3D assembly view, and the schematic diagram of an improved interlock device for locker according to a second embodiment of the present invention. Since the cylinder 2, the poking rod 3, the latch base 4, the plural wedging blocks 5, the latch structure 6, the lid 9 and the safety device 7 used in the improved interlock device of the second embodiment of the invention are similar, and thus same numerals and nomenclature are used, and the position, material used and procedure have been described in detail in the foregoing embodiment shown in FIG. 3, and thus will not be described further hereinafter. The major difference of this preferred embodiment from the first embodiment resides on the different structures formed by the void of the frame 8. The improved interlock device of the second embodiment use a fixing device 8b instead of the frame 8 to fix the improved interlock device directly to the wall 8a. By the cooperation of the fixing device 8b and the wall 8a, the latch structure 6 also can fitted in the fixing device 8b and is capable of moving upwardly and downwardly, such that not only can achieve the same function as that shown in FIG. 3, but also can greatly reduce the manufacturing cost of the improve interlock device so as to enhance market competitiveness.

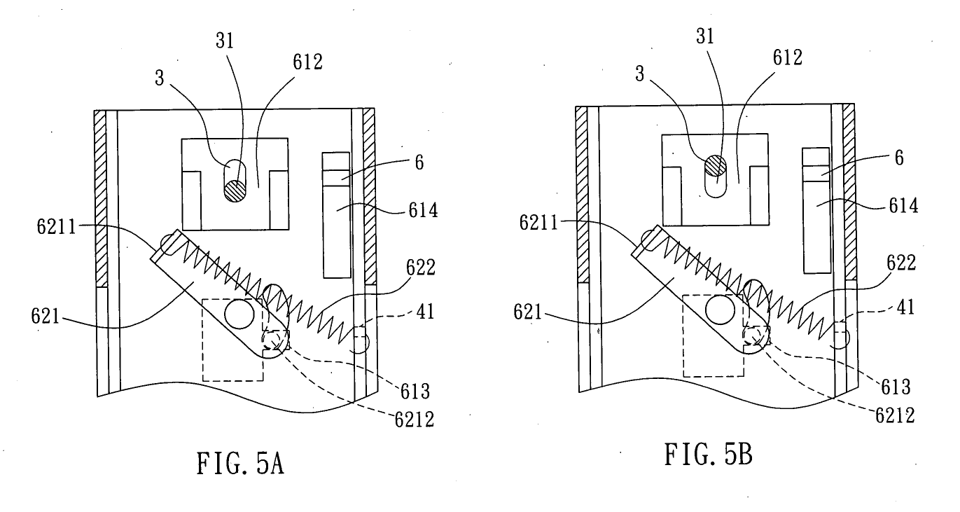

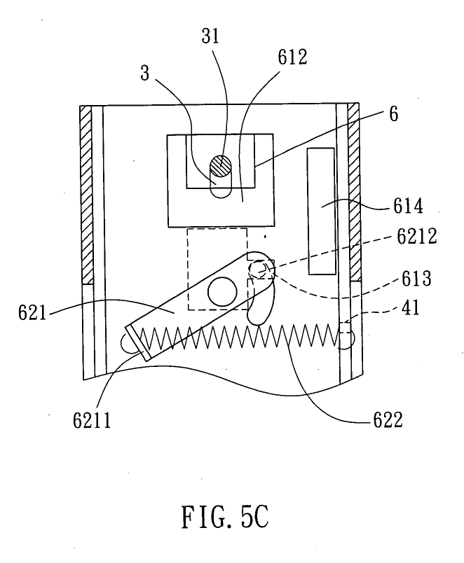

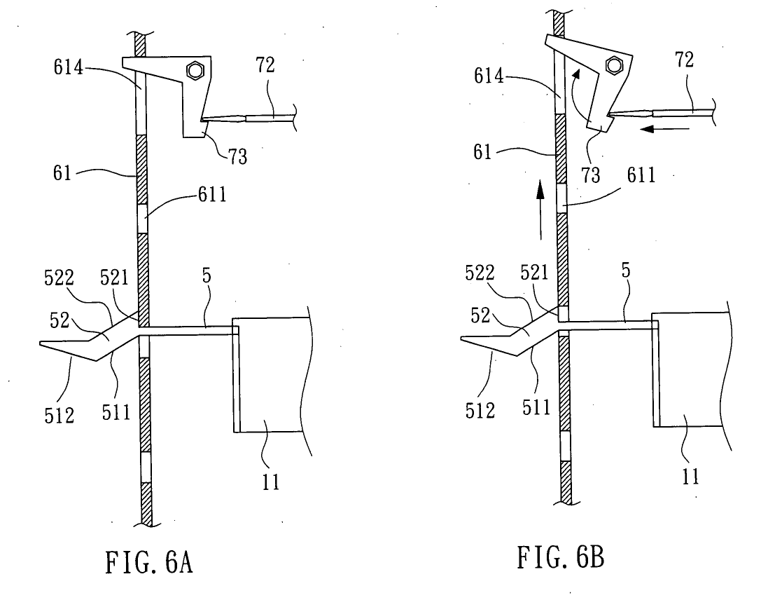

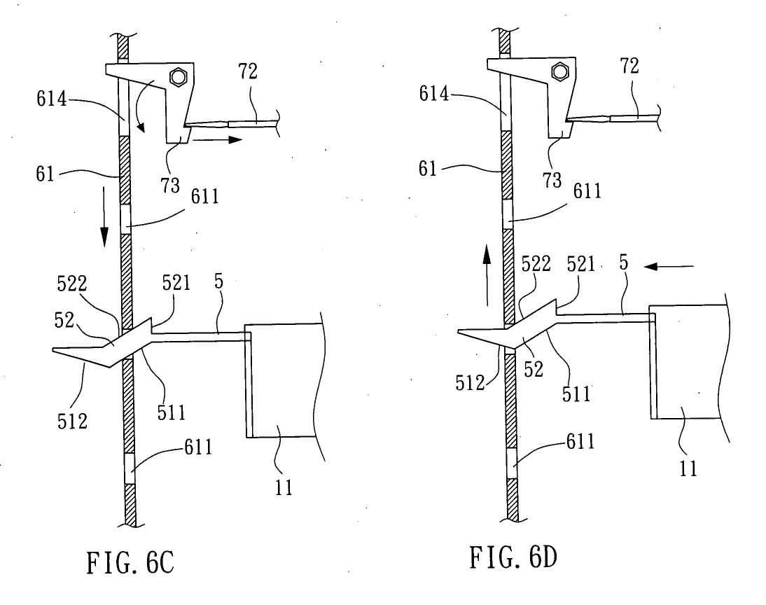

When the present invention is in a locked state, the curved hook 31 arranged at the tail of the poking rod 3 is rotated to a lower position and passes the first groove 612 of the latch piece 61 while the latch piece 61still remain in the position of the locked state as seen in FIG. 5A. Simultaneously, the lower rim of the latch hole 611, abuts against the abutting surface 521 of the locking-up part 52 arranged above the wedging block 5 such that the drawer 11 engaged with the wedging block 5 is locked and can not be pulled out as seen in FIG. 6A. When the cylinder 2 is rotated to bring along the poking rod 3, the curved hook 31 is rotate to an upper position, a predefined gap exists between the curved hook 31 and the lower rim of the first groove 612 while the latch piece 61 remains at the lock position by the activation of the poke-positioning mechanism 62. Therefore, when a user wants to open the drawer 11, it is required to press the button 71 of the safety device 7 such that the linkage rod is driven to push the blocking piece 73, and the blocking piece 73 is being rotated to push the latch piece 61 enabling the upper rim of the latch hole 611 to be disposed slightly higher than the top of the locking-up part 52 of the wedging block 5 as seen in FIG. SC and FIG. 6B. Therefore, all the drawers of the locker 1 can be opened.

When the user draws out one drawer 11 of the locker 1, the back slanting surface 511 at protruding part 51 of the wedging block 5 is in contact with the lower edge of the latch hole 611 for pressing the latch hole 611 downwardly, such that the entire latch piece 61 is moved downwardly (as shown in FIG. 6C) and thus brings along the wedge block 5 and the linkage rod 72 to resume the originally locked up position. At this time, all the other unopened drawers 11 will be unable to be drawn out and thus the function of drawing only one drawer at a time is achieved.

When a user intends to close an opened drawer 11, he can push the drawer 11 directly to make the slanting surface 522 of the locking-up part 52 arranged at the upper portion of the wedging block 5 to engage with the upper rim of the latch hole 611 so as to push the latch piece 61 to move upwardly as seen in FIG. 6D. After the locking-up part 52 passes through the latch hole completely, the latch piece can be returned to the original locked up position by the activation of the poke-positioning mechanism 62.

When a user intends to unlock the locker 1, a key can be used to rotate the cylinder 2 for bringing along the poking rod 3 such that the curved hook 31 at the poking rod's tail is upward-rotated to the unlock position. However, the button 71 is still required to be press down to enable a upward movement of the latch piece 61 for the drawer 11 to be unlocked since the latch piece 61 is still in the locked up position as seen in FIG. 6B.

On the other hand, when a user intends to lock up the locker 1, a key can be used to rotate the cylinder 2 for bringing along the poking rod 3 such that the curved hook 31 at the poking rod's tail is downward-rotated to engage with the lower rim of the first groove 612 of the latch piece 61 and enable the latch piece 61 to move downward to a locked up position as seen in FIG. 5A. At the moment, the safety device ensured the latch piece 61 can not be presses to unlock the locker 1.

In addition, the linkage rod 72 and the curved hook 31 disposed at the tail of the poking rod 3 are guided respectively by the first trough 90 and the second rough 91 such that the linkage rod 72 and the poking rod 3 can be placed at a predefined position in respective without derailing.

Since the latch piece 61 of the invention is moved in the latch base 4 with a vertically moving manner, so it is unlikely to happen the situation that the action of the latch piece 61 is influenced by the protrusion or dropping of the articles stored in the locker 1. Compared with the conventional rotary type locking up structure, the invention has the advantage of effectively maintaining a precise lock/unlock operation. Therefore, the shortcoming of a convention locking up structure that it can't be function normally because of the blocking of the articles protruded or dropped in the locker may be solved.

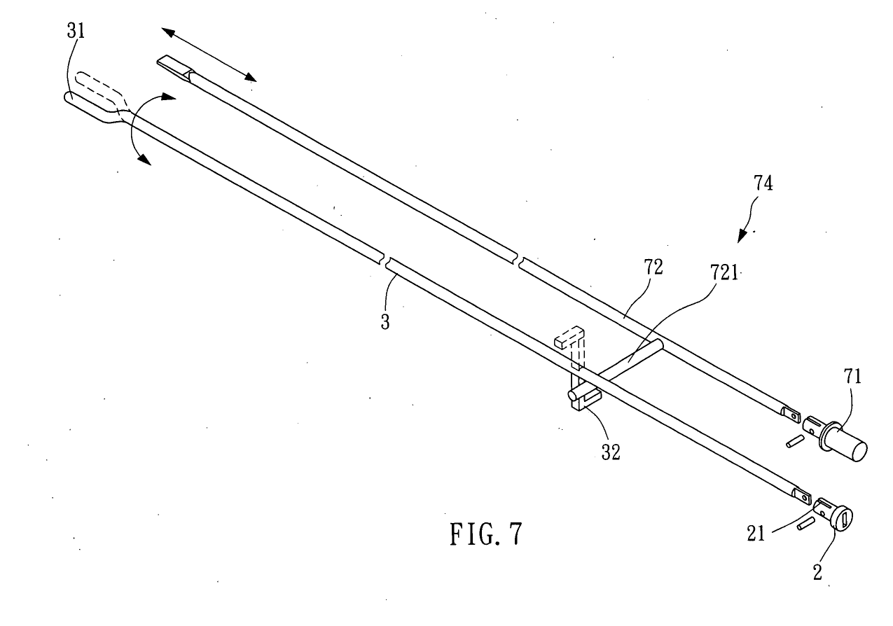

Additionally, in order to prevent a careless user from pushing in an opened drawer and causing the damage of the latch structure, the present invention provides damage proof mechanism 74 as seen in FIG. 7, comprising a stopping block 32 and a protruding part 721. The damage proof mechanism 74 is capable of increasing the gap between the upper rim of the curved hook 31 and the upper rim of the first groove 612 as the locker is locked for enabling the same to be slightly larger than the height of the abutting surface 521 of the locking-up part 52 of the wedging block 5 such that when the cylinder 2 is rotated to bring along the poking rod 3 enabling the curved hook 31 to be rotated downwardly to the lower position, the latch piece 61 can remain at the locking up position by the activation of the poke-positioning mechanism 62. Wherein, the protruding part 721 is arranged at a side of the linkage rod 72 near the poking rod 3, and the stopping block 32 is arranged on the poking rod 3 at a position corresponding to the of the protruding part 721, such that the stopping block 32 is disposed at the side corresponding to the protruding part 721 for blocking the protruding part 721 while the curved hook 31 is rotated downward, and thus the button 71 can not be pressed down. By the design of the foregoing damage proof mechanism 74, when the cylinder 2 is rotated to bring along the poking rod 3 enabling the curved hook 31 to be rotated downwardly to the lower position, the latch piece 61 can remain at the locking up position by the activation of the poke-positioning mechanism 62, and a predefined gap existing between the curved hook 31 and the upper rim of the first groove 612 of the latch piece 61, the stopping block 32 of the poking rod 3 can effectively prevent the button 71 and the linkage rod 72 of the safety device from being activated to ensure the locking up state. In addition, when a user intends to close an opened drawer 11, he can push the drawer 11 directly to make the slanting surface 522 of the locking-up part 52 arranged at the upper portion of the wedging block 5 to engage with the upper rim of the latch hole 611 so as to pull up the latch piece 61, and after the locking-up part 52 passes through the latch hole completely, the latch piece can be returned to the original locked up position by the activation of the poke-positioning mechanism 62 so as to prevent wedging block 5 from impacting the latch piece 61 directly and causing damage.

However, the aforementioned description is only the preferable embodiments according to the invention and, of course, can not be applied as a limitation to the field of the invention, and any equivalent variation and modification made according to the claims claimed thereinafter still possess the merits of the invention and are still within the spirits and the ranges of the invention, so they should be deemed as a further executing situation of the invention.

To sum up, the improved interlock structure according to the invention has the characterization of simple structure and easy maintenance. By changing the latch structure of using a poking rod to directly bring along the latch piece to move up and down to using poking rod cooperating with a poke-positioning mechanism and a safety device to maintain the latch piece constantly in a locked up position and to be unlocked only by using the safety device, the invention can limit the number of drawer to be opened at a time, and can prevent the drawer to be opened accidentally, and also may push in an unclosed drawer directly to be automatically locked without damaging. Moreover, the latch piece of the invention is arranged in the latch base to be moved up and down so, compared with the locking up structure of prior rotary type, the invention may indeed avoid the occurrence of conventional shortcoming, namely, the normal function is influenced because of the blocking of the articles protruded or dropped in the locker. Accordingly, its practicability is without doubting, and the application of this patent has never been seen in any publication or in any public occasion, so its novelty and progressiveness are ensured to actually fulfill the merits regulated in the new-pattern's patent law, according to which this application is proposed so, please your esteemed members of reviewing committee afford time to review this application in favorable way and grant it as a formal patent as soon as possible.

1. An improved interlock device for locker, arranged in a locker having a plurality of drawers, comprising:
a cylinder, arranged at the upper portion of the front panel of the locker, for locking and unlocking the locker;
a poking rod, having a front end connected to the tail of the cylinder, and a tail end arranged with a curved hook, capable of being brought along to rotate by turning a key inserted inside the cylinder;
a frame, for fixing the improved interlock device;
a plurality of wedging blocks, respectively arranged at the rear side of each drawer, and each having a protruding part arranged at the outer side thereof and a locking-up part arranged above the protruding part, the locking-up part having a near-vertical abutting surface arranged at a side thereof close to the drawer, a top protruding out the top of the wedging block, and a slanting surface arranged at another side thereof;
a latch structure, comprising a latch piece, a poke-positioning mechanism, wherein the latch piece is fitted in the frame capable of moving upward and downward and is positioned by the activation of the poke-positioning mechanism, and a plurality of latch holes are respectively arranged on the latch piece at a position corresponding to each wedging block, and the size of the latch hole is proportional to that of the protruding part of the wedging block to enable the protruding part to pass through the latch hole and move within a predefined horizontal range so as to lock/unlock the locker by changing the relative position of the latch piece and the wedging block; and
a safety device, cooperating with the poke-positioning mechanism to maintain the latch piece in a lock-up position, wherein the safety device is used to push the latch piece to an unlocked position as to open the drawers.

2. The improved interlock device for locker according to claim 1, the poke-position mechanism comprising a rotating block and an elastic element, the rotating block being pivotally connected to the latch base for rotating freely and capable of being driven by the latch piece by connecting one end of the rotating block to the latch piece, and the two ends of the elastic element respectively being connected to the latch base and the rotating block for providing a resilience to restrict the movement of the rotating block to move within two predefined positions.

3. The improved interlock device for locker according to claim 2, a first fixing seat is disposed at an end of the rotating block with respect to a second fixing seat disposed on the latch base corresponding to another end of the rotating block, and the two ends of the elastic element are respectively connected to the first fixing seat and the second fixing seat, and a column is arranged at the position of the rotating block near the latch piece that is matched with a transversely arranged second groove on the latch piece and a longitudinally arranged third groove on the latch base, for enabling the column to insert into the second groove and the third groove so as to enable the rotating block to rotate while the latch piece is driven to move by an external force.

4. The improved interlock device for locker according to claim 1, wherein the pivotal point of the rotating block connecting to the latch base is positioned between the first fixing seat and the second fixing seat.

5. The improved interlock device for locker according to claim 4, wherein the two predefined positions of the first fixing seat, the pivotal point and the second fixing seat are not all aligned in a straight line.

6. The improved interlock device for locker according to claim 1, wherein the safety device further comprising a button, a linkage rod, a blocking piece and a second elastic element, the blocking piece being pivotally connected to a side of the latch base while matching with a fourth groove arranged on a corresponding position of the latch piece enabling a side of the blocking piece to pass, and the button being pivotally connected to the front of the linkage rod while the front of the button protruding the surface of the locker, and the tail of the linkage rod passing through the latch base and abutting against a side of the block piece as another side of the blocking piece being engaged with the latch piece.

7. The improved interlock device for locker according to claim 6, further comprising a damage proof mechanism, wherein the damage proof mechanism comprises a stopping block and a protruding part, capable of increasing the gap between the upper rim of the curved hook and the upper rim of the first groove as the locker is locked for enabling the same to be slightly larger than the height of the abutting surface of the locking-up part of the wedging block, in addition, the protruding part is arranged at a side of the linkage rod near the poking rod, and the stopping block is arranged on the poking rod at a position corresponding to the of the protruding part for enabling the stopping block to be disposed at the side corresponding to the protruding part for blocking the protruding part and thus blocking the activation of the safety device.

8. The improved interlock device for locker according to claim 1, further comprising a frame, being a hollow elongated square bar and arranged at the inner surface at the back of the locker.
